(19) United States
(12) Patent Application Publication
(10) Pub. No.: US 2026/0111188 A1
(43) Pub. Date: Apr. 23, 2026

(54) GENERATE PYSPARK CODE FROM SOURCE TO TARGET MAPPING DOCUMENT

(71) Applicant: The PNC Financial Services Group, Inc., Pittsburgh, PA (US)

(72) Inventors: Dave Blackett, Pittsburgh, PA (US); Daniel Martz, Pittsburgh, PA (US); Mark Sokol, Pittsburgh, PA (US); Brian Stoneburner, Pittsburgh, PA (US)

(73) Assignee: The PNC Financial Services Group, Inc., Pittsburgh, PA (US)

(21) Appl. No.: 19/357,661

(22) Filed: Oct. 14, 2025

Related U.S. Application Data
(63) Continuation of application No. 19/193,707, filed on Apr. 29, 2025.
(60) Provisional application No. 63/708,902, filed on Oct. 18, 2024.

(51) Int. Cl. G06F 8/35

(52) U.S. Cl. CPC G06F 8/35

(57) ABSTRACT

A system for outputting standardized code that represents large amounts of data is disclosed. In some embodiments, large amounts of data, such as financial data, may be converted into a standardized source to target mapping document, which may include requests to build code and instructions to transform the data. In some embodiments, the standardized source to target mapping document may then be input into a machine learning model, which may be prompted to output standardized code based on the standardized source to target mapping document. In some embodiments, the prompting of the machine learning model may be refined to further output refined code.

### BACKGROUND

Many large entities, such as banks and other financial institutions, have access to large amounts of consumer information, such as financial data. This data must be kept secure while simultaneously being easily accessible so that it can be utilized across the financial institution. In order to make this data more accessible, financial institutions may have source to target mapping (STM) documents prepared so that the data can be transformed from its initial source into a user-friendly format, such as code. However, there are challenges in the industry with the efficiencies and resulting format in the process of converting the STM documents.

Accordingly, in view of these and other deficiencies in current techniques, technical solutions are needed to efficiently utilize STM documents to transform data from an initial source into a more user-friendly data format, such as code. In particular, solutions may include standardization of the source to target mapping documents and may use machine learning models to automate standardized code generation.

### SUMMARY

The disclosed embodiments describe computer readable mediums, systems, and methods for converting unstructured data, such as unstructured data relating to loan accounts at a financial institution, into a more user-friendly format. For example, the system and method may include accessing a first database of data of at least one user and converting the data of the at least one user into a standardized source to target mapping document. In some embodiments, the source to target mapping document may include lines of data from the user, a request to build code in each line of data of the at least one user, and instructions within each line for transformation of data of the at least one user. In some embodiments, the instructions within each line for data transformation include identifying lines of data of the at least one user that can be grouped together, forming at least one group of data of the at least one user, and transforming the at least one group of data of the at least one user. In some embodiments, the standardized source to target mapping document may be stored in a second database. The system and method may further include inputting the standardized source to target mapping document into a machine learning model, such as a large language model, prompting the machine learning model to output standardized code, and outputting standardized code based on the standardized source to target mapping document.

According to some embodiments, the user may have a loan account with a financial institution.

According to some embodiments, the data from the loan account of the user may include financial information about the loan.

According to some embodiments, the lines of data in the source to target mapping documents that cannot be grouped together may be transformed individually.

According to some embodiments, the large language model may be trained. The large language model may be trained by adjusting one or more prompts of the large language model using one or more rule sets to output a refined standardized code.

Throughout this disclosure, the phrase “disclosed embodiments,” refers to examples of ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. Likewise, the fact that some “disclosed embodiments” are described as exhibiting a feature or characteristic does not mean that other disclosed embodiments cannot share that feature or characteristic.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 depicts an exemplary conventional solution for data utilization, which lacks the ability to efficiently transform data into a user-friendly code format, consistent with disclosed embodiments.

FIG. 2 depicts an exemplary solution of data being accessed and preparing standardized STM documents to more efficiently transform the data, consistent with disclosed embodiments.

FIG. 3 is a block diagram showing an example server, consistent with disclosed embodiments.

FIG. 4 depicts an exemplary process of transforming data into standardized code through the use of standardized STM documents and a machine learning model, consistent with disclosed embodiments.

FIG. 5 depicts an exemplary process of outputting refined standardized code based on refined prompting of a machine learning model, consistent with disclosed embodiments.

FIG. 6 depicts an exemplary process of transforming data into standardized code through the use of standardized STM documents and a machine learning model, consistent with disclosed embodiments.

FIG. 7 depicts an exemplary process of transforming data into a standardized code through the use of standardized STM documents and a machine learning model, consistent with disclosed embodiments.

FIG. 8 depicts an exemplary process of transforming data into a standardized code through the use of standardized STM documents and a machine learning model, consistent with disclosed embodiments.

### DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration.

Additionally, some of the described embodiments or elements thereof can occur or be performed simultaneously, at the same point in time, or concurrently.

Reference will now be made in detail to the disclosed embodiments, which are illustrated in the accompanying drawings.

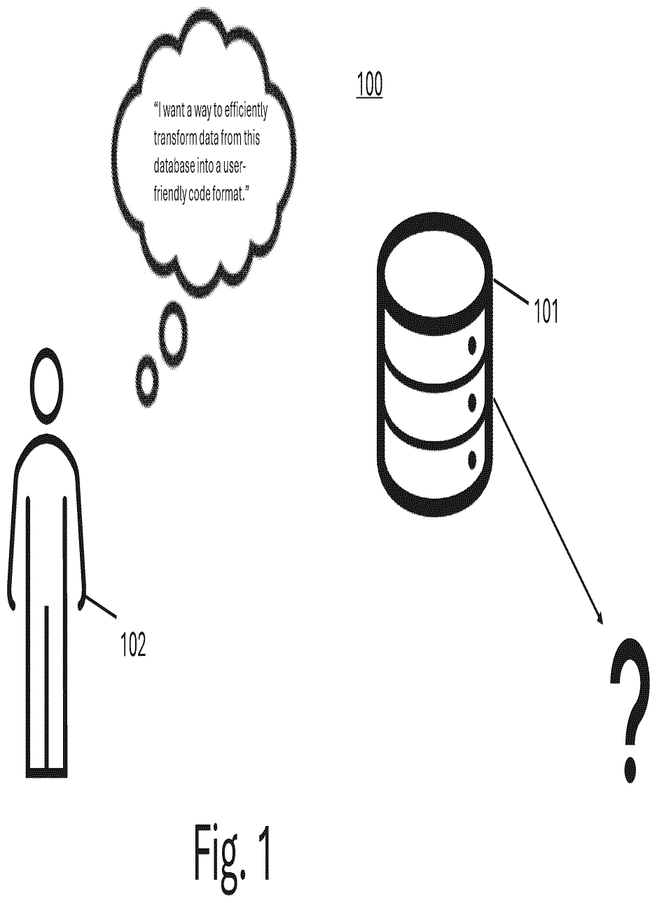

FIG. 1 illustrates an exemplary system 100, representing a conventional solution for data utilization, which lacks the ability to efficiently transform data into a user-friendly code format. System 100 may include a database 101 containing data, but system 100 may have no clear step for transforming the data into a standardized, user-friendly format. User 102 may have a need for a mechanism to efficiently transform the format of the data from database 101 into a user-friendly code format. In some embodiments, user 102 may be an individual, such as bank personnel seeking to utilize or analyze data more efficiently than available through system 100.

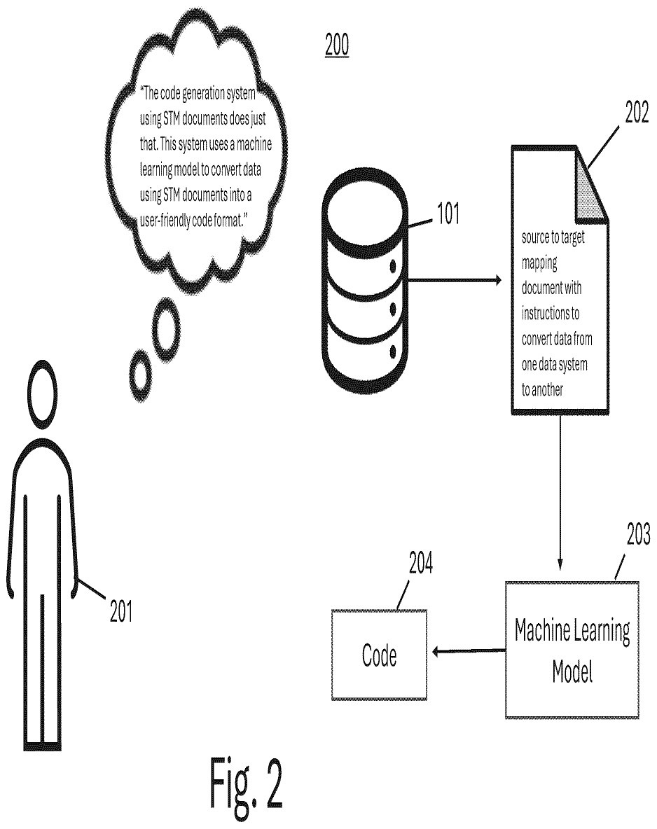

FIG. 2 illustrates an exemplary system 200 where the data from database 101 may be accessed and standardized STM documents may be prepared to efficiently convert the data into a user-friendly format. User 201 can be seen expressing that system 200 is a solution to conventional systems for data utilization that lack the ability to efficiently transform data into a user-friendly code format, as described above. In some embodiments, a user may be an individual such as bank personnel seeking to utilize or analyze data more efficiently. In some embodiments, the data accessed from database 101 may be loan account data including financial information about a loan, including the current contractual payment amount, the original loan amount, the current loan age, the remainder of time on the loan, and other data. An STM document 202 may be prepared based on the data from database 101. STM document 202 may contain instructions to convert data from database 101 in an unstandardized data format to another more user-friendly data format, such as code 204 In some embodiments, code 204 may be Python code. In some embodiments, code 204 may be specific to PySpark, a Python API for APACHE SPARK that enables real-time, large-scale data processing in a distributed environment using Python. STM document 202, may contain instructions to convert data from database 101 from an unstandardized data format to standardized code 204. STM document 202 may be input into machine learning model 203 to generate code 204. In some embodiments, machine learning model 203 may be a large language model (LLM). In some embodiments, the machine learning model 203 may be trained or untrained. In some embodiments, the machine learning model may be trained by adjusting one or more prompts of the large language model using one or more rule sets to output a refined standardized code. In some embodiments, the one or more rule sets may include instructions prompting the large language model to output a specified code format based on the data, such as PySpark code, with specified parameters, including presenting the date of a datapoint or relaying the data in a specific order. In some embodiments, the outputted code may require refinements due to undesired or inconsistent results, such as resulting in an incorrect date format or the outputted standardized code reflecting data having been input in an improper order. As a result, one or more rule sets may have to be modified to adjust the prompting of the large language model and output a refined standardized code.

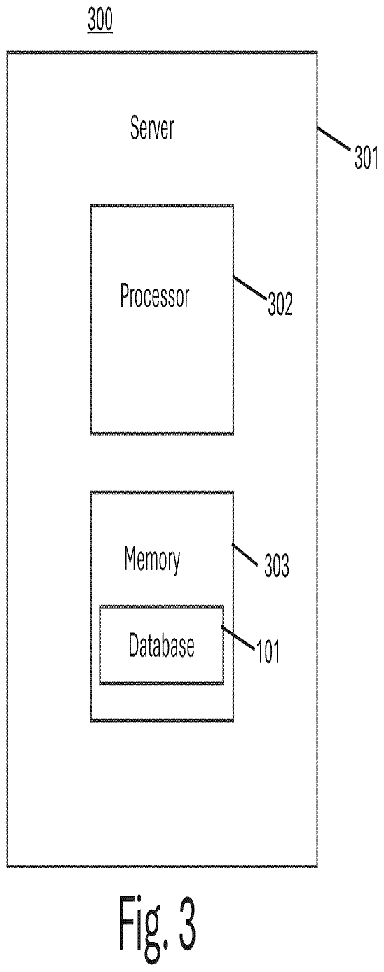

FIG. 3 is a block diagram showing an example server 301, consistent with disclosed embodiments. Server 301 may be a computing device and may include one or more dedicated processors and/or memories. For example, server 301 may include a processor (or multiple processors) 302, and a memory (or multiple memories) 303, as shown in FIG. 3.

Processor 302 may include any physical device or group of devices having circuitry configured to perform one or more logic operations on an input or inputs. For example, processor 302 may include one or more integrated circuits (IC), including application-specific integrated circuit (ASIC), microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. Processor 302 may take the form of, but is not limited to, a microprocessor, embedded processor, or the like, or may be integrated in a system on a chip (SoC). Furthermore, according to some embodiments, processor 302 may include one or more of the family of processors manufactured by Intel®, AMD®, Qualcomm®, Apple®, NVIDIA®, or the like. Processor 302 may also be based on the ARM architecture, a mobile processor, or a graphics processing unit, etc. The disclosed embodiments are not limited to any type of processor configured in server 301.

Memory 303 may include one or more storage devices configured to store instructions used by the processor 302 to perform functions related to server 301. The disclosed embodiments are not limited to particular software programs or devices configured to perform dedicated tasks. For example, the memory 303 may store a single program, such as a user-level application, that performs the functions associated with the disclosed embodiments, or may include multiple software programs. Additionally, the processor 302 may, in some embodiments, execute one or more programs (or portions thereof) remotely located from server 301.

Furthermore, memory 302 may include one or more storage devices configured to store data for use by the programs. Memory 302 may include, but is not limited to a Random Access Memory (RAM), a Read-Only Memory (ROM), a hard drive, a solid state drive, an optical disk, other permanent, fixed, or volatile memory, a CD-ROM drive, a peripheral storage device (e.g., an external hard drive, a USB drive, etc.), a network drive, a cloud storage device, or any other mechanism capable of storing instructions. In some embodiments, the at least one processor may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively and may be co-located or located remotely from each other. The processors may be coupled electrically, magnetically, optically, or by any other way that permits them to interact with each other.

In some embodiments, memory 303 may include a database 101 as described above. In some embodiments database 101 may be coupled to a server, such as server 301.

Database 101 may be included on a volatile or non-volatile, magnetic, semiconductor, tape, optical, removable, non-removable, or other type of storage device or tangible or non-transitory computer-readable medium. Database 101 may also be part of server 301 or separate from server 301. When database 101 is not part of server 301, server 301 may exchange data with database 101 via a communication link. Database 101 may include one or more memory devices that store data and instructions used to perform one or more features of the disclosed embodiments. Database 101 may include any suitable databases, ranging from small databases hosted on a work station to large databases distributed among data centers. Database 101 may also include any combination of one or more databases controlled by memory controller devices (e.g., server(s), etc.) or software. For example, database 101 may include document management systems, Microsoft SQL™ databases, SharePoint™ databases, Oracle™ databases, Sybase™ databases, other relational databases, or non-relational databases, such as mongo and others. In some embodiments, server 301 may include one or more input/output devices, communications devices, displays, and/or other interfaces (e.g., server-to-server, database to-to-database, or other network connections). Database 101 may store loan account data comprised of financial information about a loan, including the current contractual payment amount, the original loan amount, the current loan age, the remainder of time on the loan, and other data.

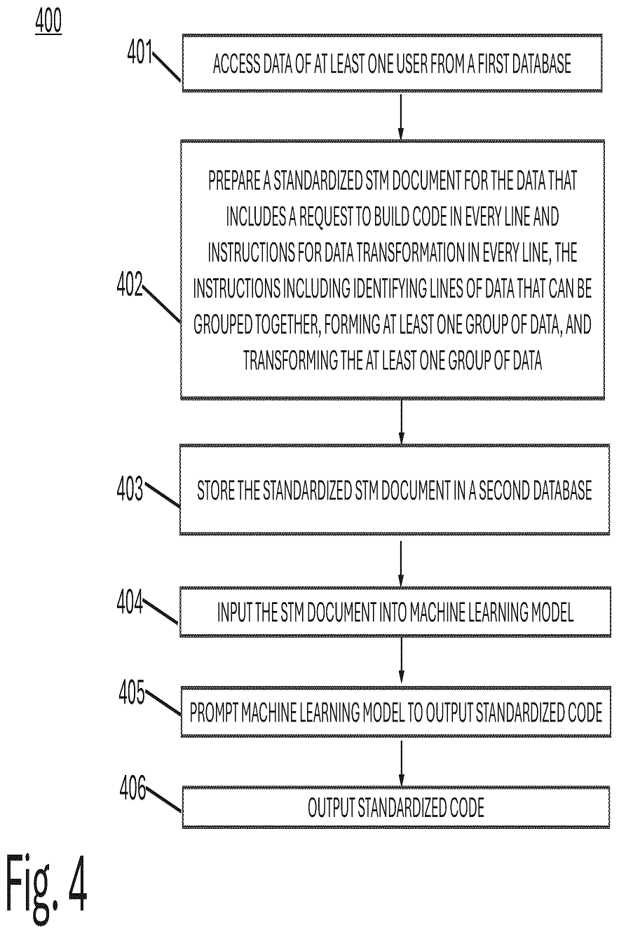

FIG. 4 is a flowchart illustrating an example process 400 for managing user memberships, consistent with the disclosed embodiments. Process 400 may be performed by at least one processing device of a server, such as processor 302, as described above. In some embodiments, a non-transitory computer readable medium may contain instructions that when executed by a processor cause the processor to perform process 400. Further, process 400 is not necessarily limited to the steps shown in FIG. 4, and any steps or processes of the various embodiments described throughout the present disclosure may also be included in process 400, including those described above with respect to FIGS. 1-3.

In step 401, process 400 may include accessing data, such as account data of at least one user, from a first database where it is stored. In some embodiments, the database may be a database such as database 101, as described above. In some embodiments, the data may be associated with at least one user.

In step 402, process 400 may include preparing a standardized STM document based on the data. The STM document may serve as instructions that may be input into a machine learning model, such as machine learning model 203. In some embodiments, the source to target mapping document may include lines of data. In some embodiments, the source to target mapping document may include a request to build code in each line of data. In some embodiments, the source to target mapping document may include instructions within each line for transformation of the data. In some embodiments, the source to target mapping document may include identifying lines of data that can be grouped together. In some embodiments, the source to target mapping document may include forming at least one group of data. In some embodiments, the source to target mapping document may include transforming the at least one group of data. In some embodiments, instructions for transforming the at least one group of data can include either a straight move to keep the data in the same format, a transformation of data from one format to another, or a hardcode for the data to always be coded as that value. In some embodiments, the database may be a database such as database 101, and the standardized STM document may be an STM document such as STM document 202, as described above. In some embodiments, there may be requests to build code and instructions for data transformation in each line of the STM document. In some embodiments, lines of data in the STM document that can be grouped together are identified, at least one group of these lines of data is formed, and the at least one group is transformed. In some embodiments, lines of data may be unable to be grouped together and may be transformed individually. In some embodiments, the data may be financial information about a loan.

In step 403, process 400 may include storing the standardized STM document, such as STM document 202 into a second database. In some embodiments, a machine learning model, such as machine learning model 203, may access the second database to access a stored STM document for the necessary instructions to output standardized code, such as code 204.

In step 404, process 400 may include inputting the STM document, containing data transformation instructions in each line, into a machine learning model, such as a large language model. In some embodiments these instructions for data transformation may include straight move, transformation, or hardcode instructions for the data. In some embodiments, the large language model may be a machine learning model, such as machine learning model 203. In some embodiments, the machine learning model may be trained or untrained, consistent with disclosed embodiments. In some embodiments, the machine learning model may be trained by adjusting one or more prompts of the machine learning model using one or more rule sets to output a refined standardized code. In some embodiments, the one or more rule sets may include instructions prompting the machine learning model to output a specified code format based on the data, such as PySpark code, with specified parameters, including presenting the date of a datapoint or relaying the data in a specific order. In some embodiments, the outputted standardized code may require refinements due to undesired or inconsistent results, such as resulting in an incorrect date format or the outputted standardized code reflecting data having been input in an improper order. As a result, one or more rule sets may have to be modified to adjust the prompting of the large language model and output a refined standardized code.

In step 405, process 400 may include prompting the machine learning model to output standardized code representing the data. In some embodiments, the code may be code 204, as described above. In some embodiments, the code may be PySpark code.

In step 406, process 400 may include outputting standardized code that represents the data.

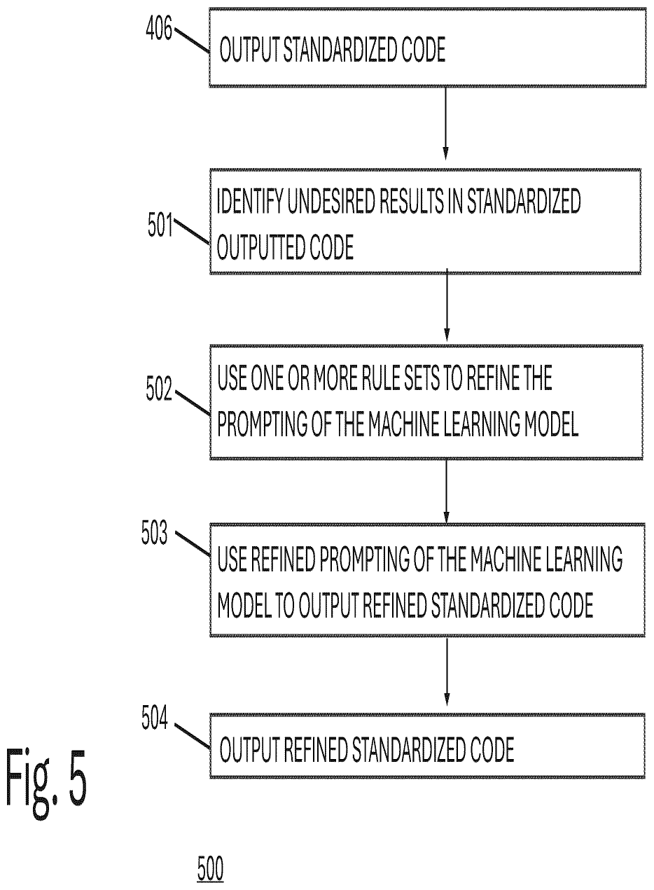

FIG. 5 is a flowchart illustrating example process 500 for refining outputted standardized code, consistent with disclosed embodiments. Process 500 may be performed by at least one processing device of a server, such as processor 302, as described above. In some embodiments, a non-transitory computer readable medium may contain instructions that when executed by a processor cause the processor to perform process 500. Further, process 500 is not necessarily limited to the steps shown in FIG. 5, and any steps or process of the various embodiments described throughout the present disclosure may also be included in process 500, including those described above with respect to FIGS. 1-4.

In step 501, process 500 may detect undesired results in outputted standardized code. In some embodiments, the code may be code 204, as described above. In some embodiments, the code may be PySpark code.

In step 502, process 500 may use one or more rule sets that may be used when the outputted standardized code includes undesired results, as detected in step 501. In some embodiments the one or more rule sets may be used to refine the prompting of the machine learning model, such as machine learning model 203.

In step 503, process 500 may include prompting the machine learning model, such as machine learning model 203, to output refined standardized code. The prompting may occur based on the one or more rule sets from step 502.

In step 504, process 500 may output a refined standardized code based on the refined prompting of the machine learning model, as shown in step 503. In some embodiments, the machine learning model may be trained to further refine the prompting of the machine learning model based on one or more rule sets and output refined standardized code until the refined standardized code includes only desired results.

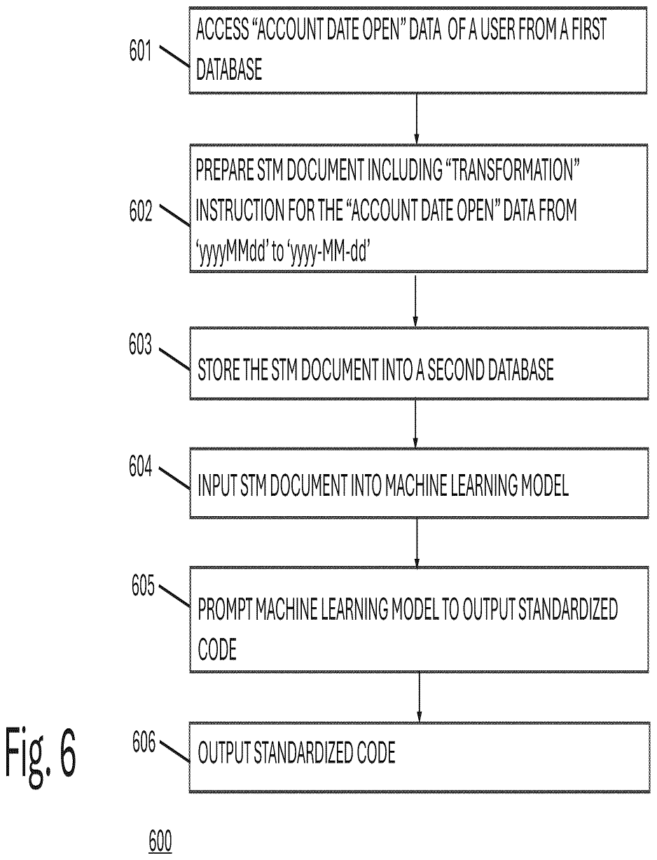

FIG. 6 is a flowchart illustrating an exemplary process 600, which is an exemplary application of process 400 in FIG. 4 for transforming data when there is a “transformation” instruction for transforming the data. Process 600 may be performed by at least one processing device of a server, such as processor 302, as described above. In some embodiments, a non-transitory computer readable medium may contain instructions that when executed by a processor cause the processor to perform process 600. Further, process 600 is not necessarily limited to the steps shown in FIG. 6, and any steps or process of the various embodiments described throughout the present disclosure may also be included in process 600, including those described above with respect to FIGS. 1-5.

In step 601, exemplary process 600 may access “account date open” data of a user from a first database containing account data of at least one user, such as database 101. “Account date open” data may be a metadata element associated with a user's account indicating when the user opened the account. In some embodiments, the “account date open” data is encrypted, and access to the data may involve one or more decryption steps, which may involve a login or access credential. In some embodiments, encryption of the “account date open” data may be specific to a single account, such that process 600 may only access the “account date open” data if permitted access to data associated with the account. In some embodiments, “account date open” data across accounts may be uniformly encrypted, such that access to “account date open” data for one account permits access to “account date open” data for another account. In some embodiments, access to “account date open” data is through an application programming interface (API), which may require user validation. In some embodiments, only administrative users or functions may access the APL

In step 602, exemplary process 600 may include preparing an STM document, such as STM document 202, for the data accessed in step 601. The STM document may serve as instructions that may be input into a machine learning model, such as machine learning model 203. In some embodiments, the STM document may be prepared using a “transformation” data instruction. In some embodiments the “transformation” data instruction may include transforming the data from one format to another. As an example, the transformation may include, but is not limited to, an instruction to transform a date in “Account Date Open” data from a “yyyyMMdd” format to a “yyyy-MM-dd” format. Data transformation according to the “transformation” data instruction may be performed to ensure that data is in a uniform format for later processing, so that outputs from the present disclosure are in a uniform data format, even if inputs to the present disclosure are not in the uniform data format. Such transformation may facilitate data usage and access across an organization, especially if subsets of the organization use inconsistent data formats. In some embodiments, data transformation may be necessary for data to conform with programming language data formatting requirements. For example, a data usage function may require all dates to be formatted in the “yyyy-MM-dd” format, and may not operate as expected when presented with dates in the “yyyyMMdd” format.

In step 603, exemplary process 600 may store the STM document, such as STM document 202, in a second database. In some embodiments, a machine learning model, such as machine learning model 203, may access the second database to access a stored STM document for the necessary instructions to output standardized code, such as code 204. In some embodiments, the second database may be different from the first database so that STM documentation is stored separately from user data. In some embodiments, the second database may be the same as the first database so that data may be consolidated.

In step 604, exemplary process 600 may input the STM document, such as STM document 202, containing the “transformation” data instruction into a machine learning model, such as machine learning model 203. In some embodiments, the machine learning model may be trained or untrained.

In step 605, exemplary process 600 may include prompting the machine learning model, such as machine learning model 203, to output standardized code, such as code 204, based on the STM document, such as STM document 202, containing the “transformation” data instruction. In some embodiments, the machine learning model may be trained by using one or more rule sets to adjust and refine the prompting of the machine learning model to output refined standardized code, such as in step 504.

In step 606, exemplary process 600 may include outputting standardized code, such as code 204. Consistent with disclosed embodiments above, the outputted standardized code may contain undesired results, such as the undesired results identified in step 501. One or more rule sets, such as those used in step 502, may be used to refine the prompting of the machine learning model. The one or more rule sets may lead to refined prompting of the machine learning model, such as in step 503. The refined standardized code may then be output, such as in step 504.

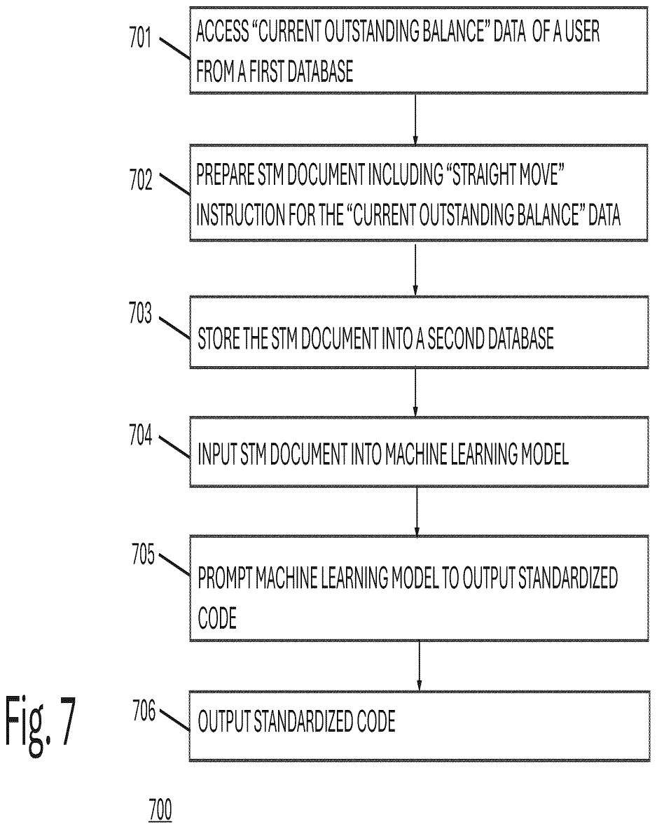

FIG. 7 is a flowchart illustrating an exemplary process 700, which is an exemplary application of process 400 in FIG. 4 for transforming data when there is a “straight move” instruction for transforming the data. Process 700 may be performed by at least one processing device of a server, such as processor 302, as described above. In some embodiments, a non-transitory computer readable medium may contain instructions that when executed by a processor cause the processor to perform process 700. Further, process 700 is not necessarily limited to the steps shown in FIG. 7, and any steps or process of the various embodiments described throughout the present disclosure may also be included in process 700, including those described above with respect to FIGS. 1-6.

In step 701, exemplary process 700 may access “current outstanding balance” data of a user being accessed from a first database, such as database 101. “Current outstanding balance” data may be a metadata element associated with a user's account indicating how much money is currently owed towards a user's account, such as a loan account. In some embodiments, the “current outstanding balance” data is encrypted, and access to the data may involve one or more decryption steps, which may involve a login or access credential. In some embodiments, encryption of the “current outstanding balance” data may be specific to a single account, such that process 700 may only access the “current outstanding balance” data if permitted access to data associated with the account. In some embodiments, “current outstanding balance” data across accounts may be uniformly encrypted, such that access to “current outstanding balance” data for one account permits access to “current outstanding balance” data for another account. In some embodiments, access to “current outstanding balance” data is through an application programming interface (API), which may require user validation. In some embodiments, only administrative users or functions may access the APL

In step 702, exemplary process 700 may include preparing an STM document, such as STM document 202, for the data in step 701. The STM document may serve as instructions that may be input into a machine learning model, such as machine learning model 203. In some embodiments, the STM document may be prepared using a “straight move” data instruction. In some embodiments, the “straight move” data instruction may include keeping the data in the same format that it is in. A “straight move” operation may be performed instead of a “transformation” operation after the system or method confirms that the data is in a usable or compliant format. Compliance with a format may involve data being in a format that an organization's other systems can use. As such, data compliance may be imposed by organizational standards.

In step 703, exemplary process 700 may store the STM document, such as STM document 202, in a second database. In some embodiments, a machine learning model, such as machine learning model 203, may access the second database to access a stored STM document for the necessary instructions to output standardized code, such as code 204. In some embodiments, the second database may be different from the first database so that STM documentation is stored separately from user data. In some embodiments, the second database may be the same as the first database so that data may be consolidated.

In step 704, exemplary process 700 may input the STM document, such as STM document 202, containing the “straight move” data instruction into a machine learning model, such as machine learning model 203. In some embodiments, the machine learning model may be trained or untrained.

In step 705, exemplary process 700 may include prompting the machine learning model, such as machine learning model 203, to output standardized code, such as code 204, based on the STM document, such as STM document 202, containing the “straight move” data instruction. In some embodiments, the machine learning model may be trained by using one or more rule sets to adjust and refine the prompting of the machine learning model to output refined standardized code, such as in step 504.

In step 706, exemplary process 700 may include outputting standardized code, such as code 204. Consistent with disclosed embodiments above, the outputted standardized code may contain undesired results, such as the undesired results identified in step 501. One or more rule sets, such as those used in step 502, may be used to refine the prompting of the machine learning model. The one or more rule sets may lead to refined prompting of the machine learning model, such as in step 503. The refined standardized code may then be output, such as in step 504.

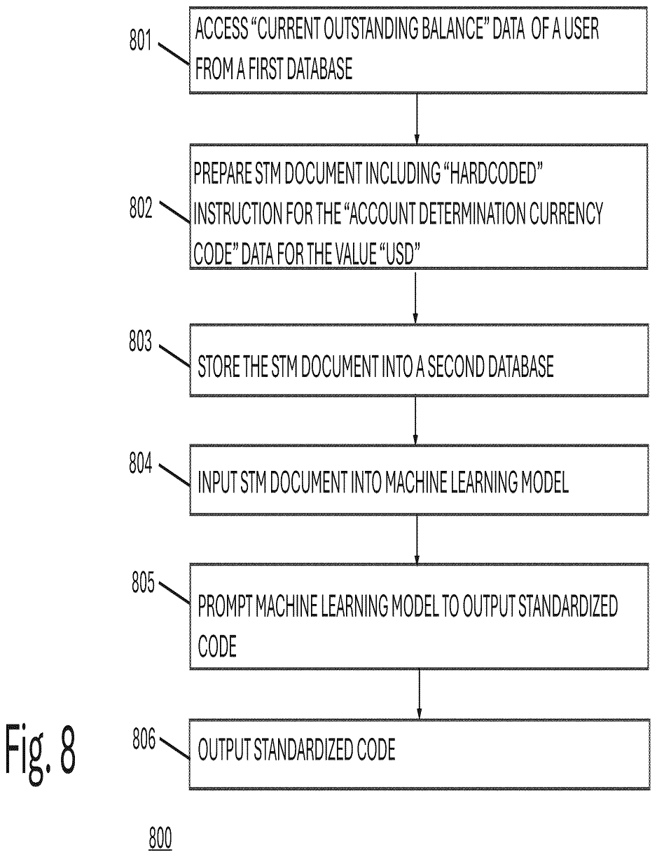

FIG. 8 is a flowchart illustrating an exemplary process 800, which is an application of process 400 in FIG. 4 for transforming data when there is a “hardcoded” instruction for the data. Process 800 may be performed by at least one processing device of a server, such as processor 302, as described above. In some embodiments, a non-transitory computer readable medium may contain instructions that when executed by a processor cause the processor to perform process 800. Further, process 800 is not necessarily limited to the steps shown in FIG. 8, and any steps or process of the various embodiments described throughout the present disclosure may also be included in process 800, including those described above with respect to FIGS. 1-7.

In step 801, exemplary process 800 may access “account determination currency code” data of a user being accessed from a first database, such as database 101. “Account determination currency code” data may be a metadata element associated with a user's account indicating the specific currency that should be used for transactions associated with the account, such as the currency used when posting transactions or determining the correct general ledger account. In some embodiments, the “account determination currency code” data is encrypted, and access to the data may involve one or more decryption steps, which may involve a login or access credential. In some embodiments, encryption of the “account determination currency code” data may be specific to a single account, such that process 800 may only access the “account determination currency code” data if permitted access to data associated with the account. In some embodiments, “account determination currency code” data across accounts may be uniformly encrypted, such that access to “account determination currency code” data for one account permits access to “account determination currency code” data for another account. In some embodiments, access to “account determination currency code” data is through an application programming interface (API), which may require user validation. In some embodiments, only administrative users or functions may access the APL

In step 802, exemplary process 800 may include preparing an STM document, such as STM document 202, for the data accessed in step 801. The STM document may serve as instructions that may be input into a machine learning model, such as machine learning model 203. In some embodiments, the STM document may be prepared using a “hardcoded” data instruction. In some embodiments, the “hardcoded” data transformation instruction may include always transforming data to be coded as a specific value. As an example, the transformation instruction may include, but is not limited, to an instruction to code “account determination currency code” data into a “USD” value. Data transformation according to the “hardcoded” data instruction may be performed to ensure that the correct general ledger accounts are used for postings, which may be especially helpful when dealing with a multi-currency environment. As an example, a “hardcode” instruction to code “account determination currency code” data into a “USD” value may indicate that posted transactions will always be denominated in US dollars.

In step 803, exemplary process 800 may store the STM document, such as STM document 202, in a second database. In some embodiments, a machine learning model, such as machine learning model 203, may access the second database to access a stored STM document for the necessary instructions to output standardized code, such as code 204. In some embodiments, the second database may be different from the first database so that STM documentation is stored separately from user data. In some embodiments, the second database may be the same as the first database so that data may be consolidated.

In step 804, exemplary process 800 may input the STM document, such as STM document 202, containing the “hardcoded” data instruction into a machine learning model, such as machine learning model 203. In some embodiments, the machine learning model may be trained or untrained.

In step 805, exemplary process 800 may include prompting the machine learning model, such as machine learning model 203, to output standardized code, such as code 204, based on the STM document, such as STM document 202, containing the “hardcoded” data instruction. In some embodiments, the machine learning model may be trained by using one or more rule sets to adjust and refine the prompting of the machine learning model to output refined standardized code, such as in step 504.

In step 806, exemplary process 800 may include outputting standardized code, such as code 204. Consistent with disclosed embodiments above, the outputted standardized code may contain undesired results, such as the undesired results identified in step 501. One or more rule sets, such as those used in step 502, may be used to refine the prompting of the machine learning model. The one or more rule sets may lead to refined prompting of the machine learning model, such as in step 503. The refined standardized code may then be output, such as in step 504.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a Wlfe.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. Some steps may be deleted, added, or modified. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1-18. (canceled)

19. A system comprising:
a memory storing instructions;
a processor configured to execute the instructions to perform operations including:
receiving a data element associated with a user from a database, the data element including a plurality of data element lines;
generating a code request document including:
a plurality of code build requests, each code build request of the plurality of code build requests associated with one data element line of the plurality of data element lines; and
a plurality of data transformation requests configured to:
group the one data element line with a second data element line of the plurality of data element lines to form a data element line group based on a common data feature between the one data element line and the second data element line; and
transform the data element line group into a common data format based on the common data feature;
providing a code standard criteria to a machine learning model configured to generate a standardized code file according to the code standard criteria;
providing the code request document to the machine learning model;
receiving the standardized code file from the machine learning model; and
executing the standardized code file.

20. The system of claim 19, wherein the operations further include:
refining the machine learning model based on the standardized code file to generate a refined standardized code file;
receiving the refined standardized code file; and
executing the refined standardized code file.

21. The system of claim 20, wherein the refining occurs as a result of the standardized code file containing an undesired code element.

22. The system of claim 21, wherein the data element includes a date, and the undesired code element is an incorrect date format.

23. The system of claim 19, wherein the plurality of data transformation requests is further configured to:
identify a third data element line of the plurality of data element lines that cannot be grouped with the one data element line; and
transform the third data element line into a second common data format.

24. The system of claim 19, wherein transforming the data element line group into the common data format involves a hardcode instruction.

25. A method comprising:
receiving a data element associated with a user from a database, the data element including a plurality of data element lines;
generating a code request document including:
a plurality of code build requests, each code build request of the plurality of code build requests associated with one data element line of the plurality of data element lines; and
a plurality of data transformation requests configured to:
group the one data element line with a second data element line of the plurality of data element lines to form a data element line group based on a common data feature between the one data element line and the second data element line; and
transform the data element line group into a common data format based on the common data feature;
providing a code standard criteria to a machine learning model configured to generate a standardized code file according to the code standard criteria;
providing the code request document to the machine learning model;
receiving the standardized code file from the machine learning model; and
executing the standardized code file.

26. The method of claim 25, further comprising:
refining the machine learning model based on the standardized code file to generate a refined standardized code file;
receiving the refined standardized code file; and
executing the refined standardized code file.

27. The method of claim 26, wherein the refining occurs as a result of the standardized code file containing an undesired code element.

28. The method of claim 27, wherein the data element includes a date, and the undesired code element is an incorrect date format.

29. The method of claim 25, wherein the plurality of data transformation requests is further configured to:
identify a third data element line of the plurality of data element lines that cannot be grouped with the one data element line; and
transform the third data element line into a second common data format.

30. The method of claim 25, wherein transforming the data element line group into the common data format involves a hardcode instruction.

31. A computer-readable medium storing instructions that, when executed, cause a processor to:
receive a data element associated with a user from a database, the data element including a plurality of data element lines;
generate a code request document including:
a plurality of code build requests, each code build request of the plurality of code build requests associated with one data element line of the plurality of data element lines; and
a plurality of data transformation requests configured to:
group the one data element line with a second data element line of the plurality of data element lines to form a data element line group based on a common data feature between the one data element line and the second data element line; and
transform the data element line group into a common data format based on the common data feature;
provide a code standard criteria to a machine learning model configured to generate a standardized code file according to the code standard criteria;
provide the code request document to the machine learning model;
receive the standardized code file from the machine learning model; and
execute the standardized code file.

32. The computer-readable medium of claim 31, wherein the instructions further cause the processor to:
refine the machine learning model based on the standardized code file to generate a refined standardized code file;
receive the refined standardized code file; and
execute the refined standardized code file.

33. The computer-readable medium of claim 32, wherein the refining occurs as a result of the standardized code file containing an undesired code element.

34. The computer-readable medium of claim 33, wherein the data element includes a date, and the undesired code element is an incorrect date format.

35. The computer-readable medium of claim 31, wherein the plurality of data transformation requests is further configured to:
identify a third data element line of the plurality of data element lines that cannot be grouped with the one data element line; and
transform the third data element line into a second common data format.

36. The computer-readable medium of claim 31, wherein transforming the data element line group into the common data format involves a hardcode instruction.
